(19) United States
(12) Patent Application Publication
(10) Pub. No.: US 2005/0154074 A1
(43) Pub. Date: Jul. 14, 2005

(54) Pressure-sensitive adhesive

(75) Inventors: Marc Husemann, Hamburg (DE); Stephan Zollner, Hamburg (DE); Roya Ibrahimi, Hamburg (DE)

Correspondence Address: Norris, McLaughlin & Marcus P.A., 18th Floor, 875 Third Avenue, New York, NY, 10022, US

(73) Assignee: tesa Aktiengesellschaft, Hamburg (DE)

(21) Appl. No.: 11/013,565

(22) Filed: Dec. 16, 2004

(30) Foreign Application Priority Data
Dec. 18, 2003 (DE) 103 59 971.1

(51) Int. Cl. C08G 2/00

(52) U.S. Cl. 522/1

(57) ABSTRACT

A pressure-sensitive adhesive composition composed of a polymer formed from acrylic and methacrylic acid derivatives and functionalized vinyl compounds, and PMMA spheres.

The invention relates to a pressure-sensitive adhesive (PSA), to processes for its preparation and to the use of such an adhesive for an adhesive tape.

For industrial and consumer applications there is a high demand for repositionable or readily removable pressure-sensitive adhesive tapes or, in general, for pressure-sensitive adhesive tapes which do not exhibit peel increase on the substrate following application. Some typical application examples include, for example, double-sided adhesive bonds. In the household sector one might contemplate the bonding of posters to the wall, for example. That application requires only relatively weakly bonding PSAs, which even over a prolonged period ought not to develop any relatively high bonding forces to the substrate, so as to prevent, for example, damage to the wall (wallpaper). In the industrial sector, in the printing industry, for example, double-sided adhesive tapes are used for bonding flexible printing plates to steel rollers (flexographic printing). In that utility the intention of the printer is to be able to reposition the printing plate in case of need, in the context of the first positioning of the printing plate, if necessary, or, when the application is at an end, to be able to remove the printing plate, together with its fixing tab, with ease, since otherwise a demanding operation becomes necessary, in order to clean the steel roller of the residues of adhesive using solvents, which is costly and time-consuming.

The bonding of protective sheets is another classic example of pressure-sensitive adhesive tapes with a low and constant bond strength over a prolonged period of time. Following application to the substrate, the protective sheet ought to be able to be removed easily and without damage. Here again, residues of pressure-sensitive adhesive are unwanted and are to be avoided.

On the basis of economic and environmental considerations there is generally a trend towards producing pressure-sensitive adhesive tapes of all kinds in a hotmelt process, since in such an operation solvents are largely excluded. Additionally there is a reduction in production time as a result of fast coating speeds.

In order to meet the demand for PSAs stable to weathering and temperature and also oxidation it is very common to use acrylate PSAs.

Acrylate hotmelt applications have already been known for a long time and were described a long time ago [Dutch Pat. 6 606 711 and 7 009 629]. In order to lower the bond strengths on polar substrates, such as steel, the prior art very often adds apolar resins. One unwanted side-effect of this method is frequently the migration of the resins within the PSA.

More recent methods use microparticles in the PSAs. Use is made here of heat-expandable microparticles [U.S. Pat. No. 5,441,810] which following exposure to heat expand and allow greater ease of removal from the substrate. A disadvantage is of course the increase in temperature required before removal of the PSA. Additionally many particles are also employed as tacky addition components [U.S. Pat. No. 3,857,731]. These are prepared, for example, according to Bohnel [U.S. Pat. No. 4,166,152] in an emulsion polymerization process. Tacky microparticles have also already been used for PSA applications [U.S. Pat. No. 4,810,763]. For repositionable PSA areas use has been made of microspheres comprising PMMA and polyacrylic acid [U.S. Pat. No. 4,735,837]. The proportions of the microspheres relative to the PSA were varied to give optimum repositionability.

In connection with a hotmelt process tacky particles have been added to hotmelt adhesives [U.S. Pat. No. 4,049,483]. As well as polymer particles it is also possible, however, to employ glass spheres in adhesives [U.S. Pat. No. 4,223,067]. Finally, numerous spray coating processes have also been described [U.S. Pat. Nos. 4,994,322 and 4,554,324].

It is an object of the invention to eliminate the disadvantages according to the prior art. The intention is in particular to specify a pressure-sensitive adhesive which exhibits no peel increase or whose peel increase is markedly reduced as compared with the prior art. The intention is further to specify processes for preparing such an adhesive and also a use of such an adhesive.

This object is achieved by the features of claims 1, 4, 5 and 8.

Advantageous embodiments of the invention are evident from the features of claims 2, 3, 6, 7 and 9.

The invention provides a pressure-sensitive adhesive comprising—based on the pressure-sensitive adhesive—
(a) from 85% to 98% by weight of a polymer formed from a comonomer composition comprising—based on the comonomer composition—
   (a1) from 70% to 99% by weight of acrylic and methacrylic acid derivatives of the formula CH₂═CH(R₁)(COOR₂) where R₁ is H or CH₃ and R₂ is an alkyl chain having 2 to 20 carbon atoms; and
   (a2) from 1% to 30% by weight of functionalized vinyl compounds; and
(b) from 2 to 15% by weight of PMMA spheres having a size of from 2 to 10 μm.

By PMMA is meant herein polymethyl methacrylate.

The PMMA spheres are advantageously not tacky spheres.

The peel increase of the pressure-sensitive adhesive of the invention, if it exhibits any at all, is markedly reduced. The pressure-sensitive adhesives of the invention are therefore low- or no-peel-increase adhesives.

In comparison to the polymer (a) alone the flow viscosity of the pressure-sensitive adhesive of the invention is changed only within very small limits (>5%) by the addition of the PMMA spheres, the bond strength on different substrates is reduced, the peel increase on different substrates is reduced or eliminated, the shear strength is increased, and the cuttability of the pressure-sensitive adhesive on a backing is improved.

The level of bond strength can be adjusted by way of the proportion of the PMMA spheres.

The non-tacky PMMA spheres can be processed and coated with acrylate PSAs in a hotmelt operation. The peel increase of the pressure-sensitive adhesive tapes thus produced, if they exhibit any at all, is markedly reduced.

The functionalized vinyl compound is preferably selected from the group consisting of maleic anhydride, styrene, styrene derivatives, vinyl acetate, acrylamides and double-bond-functionalized photoinitiators.

The PSA of the invention can be modified further for the purpose of achieving the optimum adhesive properties. To raise the cohesion it is possible before crosslinking to add crosslinkers or photoinitiators, compounds useful as crosslinkers being all bifunctional or polyfunctional compounds whose functional groups are able to undergo a linking reaction with the polyacrylates, especially addition polymerization, polycondensation or polyaddition reactions.

For acrylate hotmelts preference is given to polyfunctional acrylates which function as crosslinkers during UV curing or curing by means of ionizing radiation. Photoinitiators which can be used include benzophenone, acetophenone, benzil, benzoin, hydroxyalkylphenone, phenyl cyclohexyl ketone, anthraquinone, thioxanthone, triazine, or fluorenone derivatives.

The polymers for preparing PSAs are further optionally blended with additional resins. As resins it is possible, for example, to use terpene resins, terpene-phenolic resins, C₅ and C₉ hydrocarbon resins, pinene resins, indene resins and rosins in combination with one another. In principle, however, it is possible to use any resins that are soluble in the polyacrylate in question; reference may be made in particular to all aliphatic, aromatic and alkylaromatic hydrocarbon resins, hydrocarbon resins based on single monomers, hydrogenated hydrocarbon resins, functional hydrocarbon resins and also natural resins. The resins are generally metered preferably into the polyacrylate melt, introduction taking place using, with great preference, a twin-screw extruder.

In addition it is possible to add various fillers (such as carbon black, TiO₂, solid spheres or hollow spheres of glass or other materials, nucleating agents), expandants, compounding agents and/or ageing inhibitors.

The PSA of the invention can be processed further from the melt and so applied, for example, to a backing. This is especially advantageous for the production of adhesive tapes.

As backing material, for adhesive tapes for example, it is possible in this context to use the materials which are customary and familiar to the skilled worker, such as films (polyester, PET, PE, PP, BOPP, PVC), nonwovens, foams, woven fabrics and woven films, and also release paper (glassine, HDPE, LDPE). This list is not intended to be conclusive.

The PSA of the invention can be crosslinked thermally, by UV radiation or by ionizing radiation, such as electron beams, for example. This is particularly advantageous for the production of adhesive tapes.

Crosslinking by UV irradiation takes place in the range from 200 to 400 nm using commercially customary high-pressure or medium-pressure mercury lamps with an output of, for example, from 80 to 200 W/cm. For UV crosslinking it may be appropriate to adapt the lamp output to the belt speed or partly to shade off the belt while running it slowly, in order to lessen the thermal load on the belt. The irradiation time is guided by the design and output of the respective lamps.

The invention accordingly provides a process for preparing a pressure-sensitive adhesive of the invention, comprising the following steps:
(a) preparing a mixture comprising the components of the comonomer composition and the PMMA spheres; and
(b) polymerizing the comonomer composition.

Alternatively the PSA of the invention can be prepared from the process comprising the following:
(a) preparing a mixture comprising the components of the comonomer composition;
(b) polymerizing the comonomer composition to give the polymer; and
(c) adding the PMMA spheres to the polymer and mixing the polymer with the PMMA spheres.

The PSA of the invention can be used for an adhesive tape, with the acrylate PSA present as a single-sided or double-sided film on a backing.

The invention is elucidated in greater detail below, with reference to examples and to the attached figures. In those figures

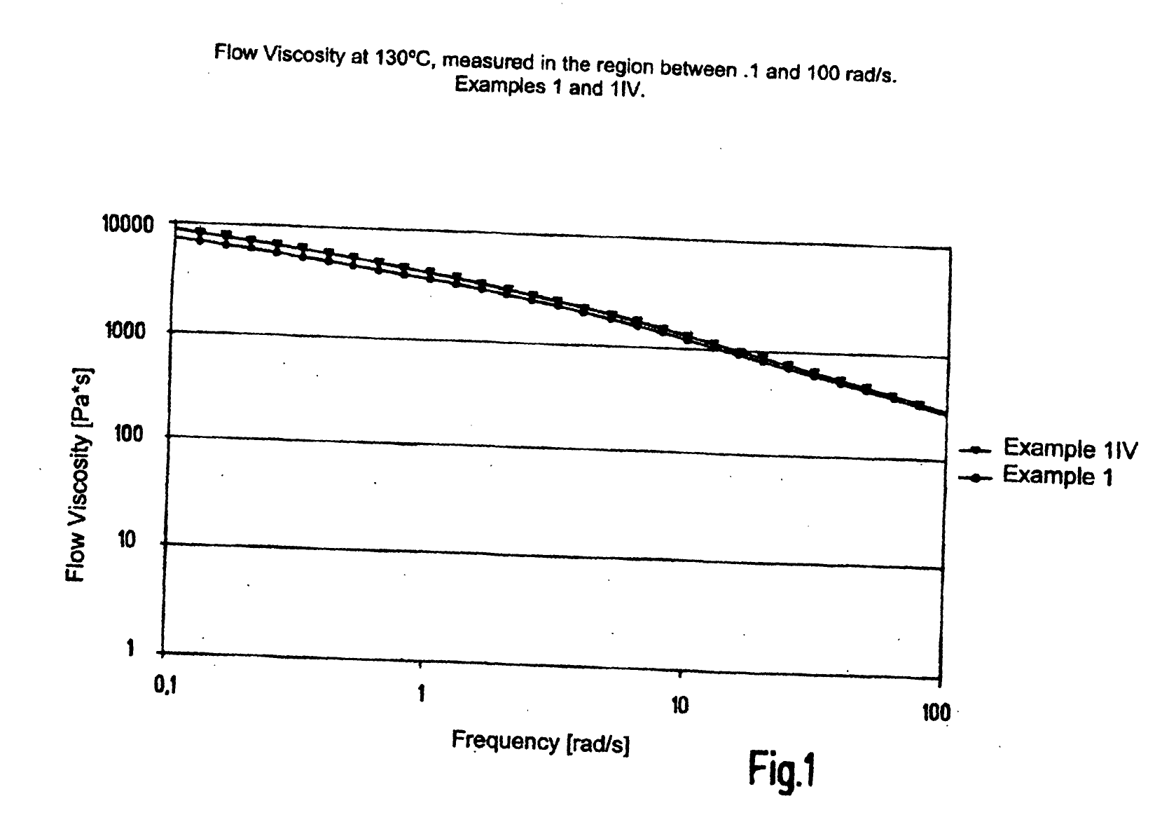

FIG. 1 shows a diagram showing the flow viscosities of a first embodiment of a PSA of the invention and also of a polymer without PMMA spheres; and

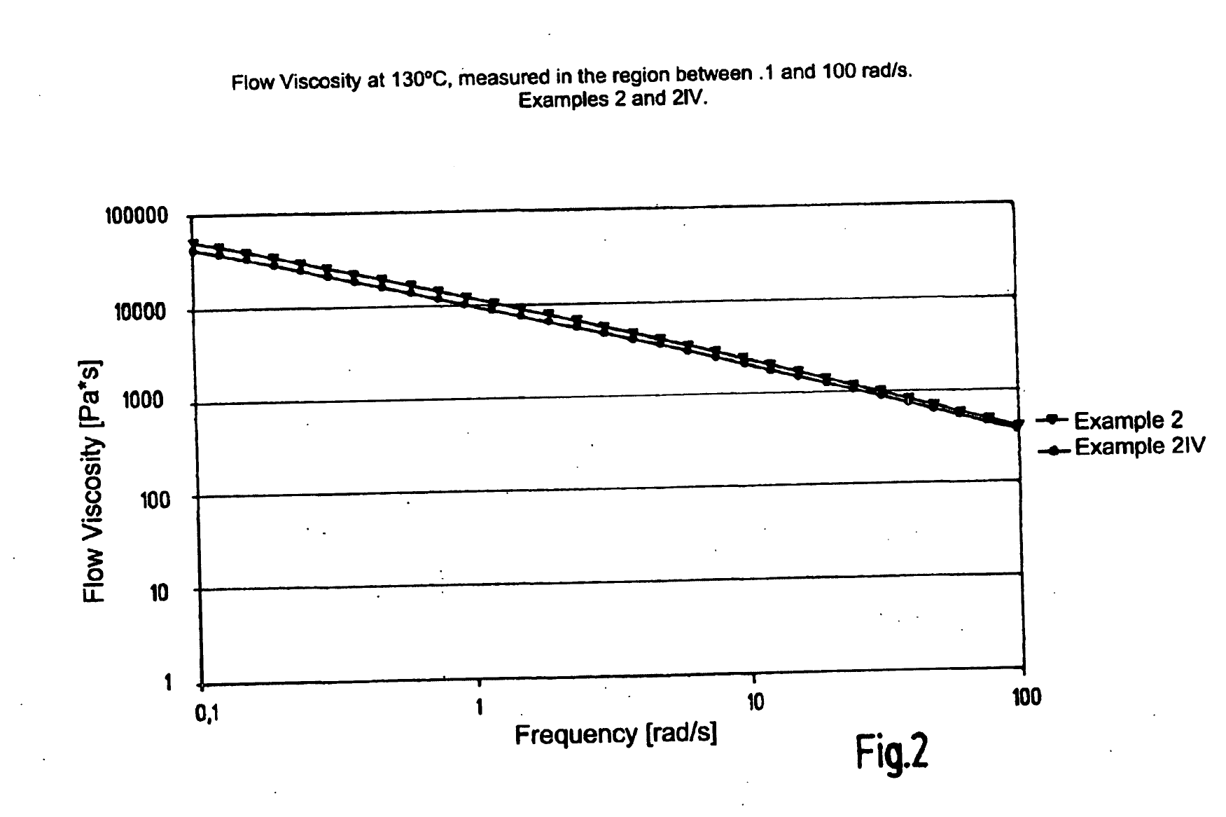

FIG. 2 shows a diagram showing the flow viscosities of a second embodiment of a PSA of the invention and also of a polymer without PMMA spheres.

### TEST METHODS

The following test methods were employed to evaluate the adhesive properties of the PSAs prepared.

Shear Strength

A 13 mm wide strip of an adhesive tape which had been coated with a PSA was applied to a smooth steel surface which was cleaned three times with acetone and once with isopropanol. The application area measured 20 mm×13 mm (length×width). The adhesive tape was subsequently pressed onto the steel backing four times using a 2 kg weight. At room temperature a 1 kg weight was fastened to the adhesive tape and the time taken for the weight to fall down was measured.

The measured shear stability times are expressed in minutes and correspond to the mean value from three measurements.

180° Bond Strength Test

A 20 mm wide strip of an adhesive tape consisting of a PSA coated onto a polyester was applied to steel plates. The adhesive tape was subsequently pressed onto the substrate using a 2 kg weight. The adhesive tape was then peeled from the substrate at 300 mm/min and at an angle of 180°. The steel plates were washed twice with acetone and once with isopropanol.

To measure the peel increase the adhesive tape was bonded to the substrate for 72 h and then immediately peeled from the substrate at 300 mm/min and an angle of 180°. The results of the measurement are expressed in N/cm and have been averaged from three measurements. All measurements were carried out at room temperature under controlled-climate conditions.

Preparation of the Polymer (a)

The aim of this invention is to produce acrylate hotmelts having little or no peel increase.

In order to demonstrate the effect of the PMMA spheres it was necessary first of all to prepare the simple polyacrylates without any addition. For this purpose a variety of polyacrylates having PSA properties were polymerized conventionally in a 2 L glass reactor or in a 200 L steel reactor. The composition of the corresponding polymers (a) is indicated in Table 1:

TABLE 1

| Example | AA [%] | 2-EHA [%] | n-BuA [%] | MA [%] | MAA [%] |
|---|---|---|---|---|---|
| 1 | 2 | 48.5 | 48.5 | 0 | 1 |
| 2 | 7 | 78 | 0 | 15 | 0 |
| 3 | 10 | 90 | 0 | 0 | 0 |
| 4 | 2 | 87 | 0 | 10 | 1 |

AA: acrylic acid
2-EHA: 2-ethylhexyl acrylate
n-BuA: n-butyl acrylate
MA: methyl acrylate
MAA: maleic anhydride

Examples 1 and 4 contain small fractions of polar comonomers, such as acrylic acid, and are therefore relatively soft. Examples 2 and 3, on the other hand, are relatively polar and are used with preference as products of greater shear strength, without high bond strength and without resin blending.

Example 1 was subsequently blended optionally with 0.5 part by weight of SR 610 (crosslinker, polyfunctional acrylate from Cray Valley) and 20 parts by weight of Norsolen M1080 (hydrocarbon resin from Cray Valley) (Table 2).

TABLE 2

Parts by weight

| | | | Norsolen |
|---|---|---|---|
| Example | Example | SR610 | M1080* |
| 1 resin | 1 | 0.5 | 20 |

*HC resin from Cray Valley

To investigate the adhesive data for Examples 1, 1 resin, 2, 3 and 4 the adhesives were applied to a standard polyester backing at 50 g/m² and crosslinked with electron beams (EB) in order to raise the cohesion. Peel increase was evaluated using the bond strength measurement at 180°. Testing was carried out both on steel (polar surface) and on PE (apolar surface).

The bond strength was measured instantaneously and after 72 h. To complete the measurements the cohesion as well was determined, via the shear stability measurement. The results of adhesives testing are summarized in Table 3.

TABLE 3

| | | BS-steel | BS-steel | BS-PE | BS-PE | SST RT |
|---|---|---|---|---|---|---|
| | EBC | instantaneous | 72 h | instantaneous | 72 h | 10 N |
| Example | dose | [N/cm] | [N/cm] | [N/cm] | [N/cm] | [min] |
| 1 | 30 kGy | 4.6 | 6.9 | 1.9 | 2.7 | 7250 |
| 2 | 30 kGy | 3.9 | 7.2 | 0.7 | 2.0 | 10000+ |
| 3 | 20 kGy | 3.8 | 7.0 | 0.9 | 2.1 | 10000+ |
| 4 | 50 kGy | 4.5 | 7.3 | 1.8 | 2.6 | 8245 |
| 1 resin | 50 kGy | 5.8 | 6.7 | 2.5 | 3.8 | 10000+ |

EBC: electron beam curing
BS-steel: bond strength on steel
BS-PE: bond strength on polyethylene
SST RT: shear stability time at room temperature

Table 3 reveals that all of the acrylate PSAs shown exhibit a peel increase. In all cases there was a drastic increase in the bond strength on steel in comparison immediately after application and after 72 h. The effect is somewhat less pronounced in the case of the resin-blended version (Example 1 resin). A similar picture can be seen for the bonds to the PE (polyethylene) substrate. Since the surface is very apolar and polyacrylates are relatively polar, the bond strengths here are at a significantly lower level. Nevertheless, even here, a distinct flow behaviour and an increase in the bond strengths are evident after 72 h. This effect is particularly manifest in the case of the very hard polyacrylates 2 and 3 of high shear strength, since these polyacrylates require a longer time to flow. The highest bond strengths are obtained with the resin-blended compound 1 resin. The shear strength is relatively high in all cases (at room temperature), with only polyacrylates 1 and 4 not attaining the limit of 10 000 minutes with a shearing force of 1 kg.

Preparation of the Inventive PSAs

The effects of admixing the PMMA spheres to give the PSAs of the invention are now depicted below. First of all a variety of mixtures with different weight fractions of PMMA spheres were prepared. The PMMA spheres used were EPS-MA 1002, EPS-MA 1004 and EPS-MA 1010 from Nippon Shokubai. The blends prepared are reported in Table 4.

TABLE 4

| | | Diameter | Weight fraction |
|---|---|---|---|
| | Example | in μm | of PMMA |
| Example | basis | PMMA spheres | spheres |
| 1II | 1 | 2 | 6% |
| 1IV | 1 | 4 | 6% |
| 1 X | 1 | 10 | 6% |
| 1% 3 | 1 | 4 | 3% |
| 1% 12 | 1 | 4 | 12% |
| 2IV | 2 | 4 | 6% |
| 3IV | 3 | 4 | 6% |
| 4IV | 4 | 4 | 6% |
| 1resin%12 | 1resin | 4 | 12% |

The examples reported in Table 4, apart from examples 1II and 1IV, were prepared conventionally in solution. The mixtures are all turbid. For the purpose of comparison, Examples 1II and 1IV were prepared by the process according to claim 4. For this purpose, prior to polymerization, the monomers, the solvent and the corresponding quantities of PMMA spheres were introduced as an initial charge, this initial charge was stirred and inhibited with nitrogen gas, and polymerization was initiated in the same way as for Example 1. After a reaction time of 22 h the polymerizations were terminated and the polyacrylates were analyzed by GPC, the homogeneously distributed PMMA having been filtered off beforehand. The GPC measurements showed no differences in the average molecular weight or in the polydispersity of the material as compared with polymerization without PMMA. Hence the PMMA spheres do not influence the polymerization (as regulators, for example) and therefore do not need to be metered in later, which would be costly and inconvenient. Such later addition, however, is also possible, simply by metering in the PMMA spheres as a solid, with subsequent mixing in the compounder.

The examples listed in Table 4 were intended initially for investigation of the effect of the size of the PMMA spheres and their proportion in the PSA. The purpose of the other mixtures was to ensure that the conclusions drawn can also be extrapolated to different PSAs.

Before the inventive PSAs containing PMMA spheres were subjected to adhesives testing, a number of Theological investigations were carried out exemplarily for the purpose of the flow viscosity. The flow viscosity is a limiting factor for the hotmelt operation and ought not to rise as a result of the PMMA spheres. The flow viscosity was determined at a typical processing temperature of 130° C. FIGS. 1 and 2 depict the results in the form of graphs.

FIGS. 1 and 2 reveal that the flow viscosities are not adversely affected by the PMMA spheres. In fact the flow viscosity of the acrylate. PSAs blended with PMMA spheres (polymer (a)) is somewhat below the original flow viscosity. Consequently the admixing of PMMA spheres to polymer (a) does not affect the hotmelt processability. Sample coatings carried out through the hotmelt die showed, moreover, that the PMMA spheres do not coagulate and give rise to caking, which might in turn disrupt the operation. Consequently PMMA-acrylate PSA blends are fully hotmelt-compatible.

The adhesive effects were subsequently investigated in sample coatings. In the same way as for the base polymers 1, 2, 3, 4, and 1 resin, coating took place at 50 g/m² and crosslinking took place on the standard polyester backing with the identical EBC doses for the purpose of raising the cohesion. The results of the adhesives tests are set out in Table 5.

TABLE 5

| | | BS-steel | BS-steel | BS-PE | BS-PE | SST RT |
|---|---|---|---|---|---|---|
| | EBC | instantaneous | 72 h | instantaneous | 72 h | 10 N |
| Example | dose | [N/cm] | [N/cm] | [N/cm] | [N/cm] | [min] |
| 1II | 30 kGy | 2.4 | 2.6 | 1.0 | 1.1 | 10000+ |
| 1IV | 30 kGy | 2.5 | 2.5 | 1.0 | 1.2 | 10000+ |
| 1X | 30 kGy | 2.5 | 2.7 | 0.9 | 1.0 | 10000+ |
| 1% 3 | 30 kGy | 3.0 | 3.0 | 1.0 | 1.2 | 10000+ |
| 1% 12 | 30 kGy | 2.1 | 2.1 | 0.5 | 0.5 | 10000+ |
| 2IV | 30 kGy | 2.5 | 2.7 | 0.6 | 0.7 | 10000+ |
| 3IV | 20 kGy | 2.6 | 2.4 | 0.7 | 0.7 | 10000+ |
| 4IV | 50 kGy | 2.9 | 3.0 | 0.8 | 1.0 | 10000+ |
| 1 resin % 12 | 50 kGy | 4.7 | 4.9 | 1.9 | 2.0 | 10000+ |

Comparing the results from Table 3 with those from Table 5 it is apparent that through the addition of PMMA spheres the bond strength, both on steel and on PE, has dropped sharply. On the other hand, in virtually all cases the peel increase is very low or there is no longer any at all. A comparison of Examples 1II, 1IV and 1X shows that the size of the PMMA spheres has no great effect for a given weight fraction. Within the bounds of measurement error, the bond strength values for steel and PE are all situated at the same level. The fraction, on the other hand, has a somewhat greater effect. Comparing 1IV with 1%3 and 1%12 it can be seen that as the amount of PMMA spheres increases the bond strength on steel and PE drops. The peel increase is low in all cases. A similar picture arises for Examples 2IV, 3IV and 4IV. For the resin-blended version 1 resin %12, as well, a reduced bond strength on steel and PE was measured, although the figures are still above those of the polyacrylates without added resin. For 1 resin %12 as well only a very low peel increase is measured. A comparison of the shear stability times yields a somewhat increased cohesion for Examples 1 and 4. Evidently the PMMA spheres distribute the internal stresses somewhat more effectively in the adhesive during the shear test, and the shear stability times go up.

The addition of PMMA spheres to the polyacrylates thus results in a lower bond strength on steel and polyethylene. Nevertheless the peel increase otherwise typical of polyacrylates is markedly reduced or even eliminated. The same result was found for a polyacrylate resin mixture. Besides resins, however, it is also possible as well to add other components customary for pressure-sensitive adhesives. Besides plasticizers, photoinitiators and fillers, contemplation might also be given, for example, to ageing inhibitors. Cutting tests with high-tack polyacrylate PSAs (high resin fraction, added plasticizers) have shown that with a relatively high fraction of PMMA spheres (greater than 6%) the adhesives have significantly better cuttability. These adhesives do not transfer so quickly to the blade, so that the cutting behaviour—particularly with the blade at a standstill and subsequent advancement—is significantly improved. This is a further advantage of the pressure-sensitive adhesive of the invention.

1. Pressure-sensitive adhesive comprising, based on the weight of pressure-sensitive adhesive,
(a) from 85% to 98% by weight of a polymer formed from a comonomer composition comprising, based on the weight of comonomer composition,
(a1) from 70% to 99% by weight of acrylic and/or methacrylic acid derivatives of the formula CH₂═CH(R₁)(COOR₂) where R₁ is H or CH₃ and R₂ is an alkyl chain having 2 to 20 carbon atoms; and
(a2) from 1% to 30% by weight of functionalized vinyl compounds; and
(b) from 2 to 15% by weight of PMMA spheres having a size of from 2 to 10 μm.

2. Pressure-sensitive adhesive according to claim 1, wherein the functionalized vinyl compound is selected from the group consisting of maleic anhydride, styrene, styrene derivatives, vinyl acetate, acrylamides and double-bond-functionalized photoinitiators.

3. Pressure-sensitive adhesive according to claim 1 further comprising resins selected from the group consisting of terpene resins, terpene-phenolic resins, C₅ and C₉ hydrocarbon resins, pinene resins, indene resins and rosins and mixtures thereof.

4. Process for preparing a pressure-sensitive adhesive according to any one of claims 1 to 3, comprising the steps of
(a) preparing a mixture comprising the components of the comonomer composition and the PMMA spheres; and
(b) polymerizing the comonomer composition.

5. Process for preparing a pressure-sensitive adhesive according to any one of claims 1 to 3, comprising the steps of
(a) preparing a mixture comprising the components of the comonomer composition;
(b) polymerizing the comonomer composition to give the polymer; and
(c) adding the PMMA spheres to the polymer and mixing the polymer with the PMMA spheres.

6. Process according to claim 4, wherein the mixture in step (a) is prepared in solution.

7. Process according to claim 4, wherein the polymer is prepared as a hotmelt.

8. An adhesive tape comprising a backing having the pressure-sensitive adhesive of any one of claims 1 to 3 on one or both sides thereof.

9. A method for preparing the adhesive tape of claim 8, which comprises applying the pressure-sensitive adhesive of claims 1, 2 or 3 to one or both sides of a backing.

10. Process according to claim 5, wherein the mixture in step (a) is prepared in solution.

11. Process according to claim 5, wherein the polymer is prepared as a hotmelt.
